(19) United States
(12) Patent Application Publication
(10) Pub. No.: US 2026/0122662 A1
(43) Pub. Date: Apr. 30, 2026

(54) WIRELESS LOCAL-AREA NETWORK (WLAN) CHANNEL MANAGEMENT IN THE PRESENCE OF AMBIENT POWER (AMP) DEVICES

(71) Applicant: Cisco Technology, Inc., San Jose, CA (US)

(72) Inventors: Leo Caldarola, Morrens (CH); Robert E. Barton, Richmond (CA); Domenico Ficara, Essertines-sur-Yverdon (CH); Indermeet S. Gandhi, San Jose, CA (US)

(73) Assignee: Cisco Technology, Inc., San Jose, CA (US)

(21) Appl. No.: 19/005,732

(22) Filed: Dec. 30, 2024

Related U.S. Application Data
(60) Provisional application No. 63/615,923, filed on Dec. 29, 2023.

(51) Int. Cl. H04W 72/542; H04W 72/0453

(52) U.S. Cl. CPC H04W 72/542; H04W 72/0453

(57) ABSTRACT

Wireless Local-Area Network (WLAN) channel management in the presence of Ambient Power (AMP) devices may be provided. First, an Access Point (AP) may receive a data packet indicating a perceived Received Signal Strength Indicator (RSSI) that a Backscatter Device (BKD) received a signal at from the AP. Then the AP may provide a controller the perceived RSSI that the BKD received the signal at from the AP and a frequency on which the AP received the data packet. Next, the AP may receive channel assignment instructions from the controller based on the perceived RSSI that the BKD received the signal at from the AP and the frequency on which the AP received the data packet.

### RELATED APPLICATION

Under provisions of 35 U.S.C. § 119(e), Applicant claims the benefit of U.S. Provisional Application No. 63/615,923, filed Dec. 29, 2023, which is incorporated herein by reference.

### TECHNICAL FIELD

The present disclosure relates generally to providing Wireless Local-Area Network (WLAN) channel management in the presence of Ambient Power (AMP) devices.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Wireless Local-Area Network (WLAN) channel management in the presence of Ambient Power (AMP) devices;

FIG. 2 is a flow chart of a first method for providing WLAN channel management in presence of AMP devices;

FIG. 3 is a block diagram of an operating environment for WLAN channel management in the presence of AMP devices; and

FIG. 4 is a block diagram of a computing device.

### DETAILED DESCRIPTION

### Overview

Wireless Local-Area Network (WLAN) channel management in the presence of Ambient Power (AMP) devices may be provided. First, an Access Point (AP) may receive a data packet indicating a perceived Received Signal Strength Indicator (RSSI) that a Backscatter Device (BKD) received a signal at from the AP. Then the AP may provide a controller the perceived RSSI that the BKD received the signal at from the AP and a frequency on which the AP received the data packet. Next, the AP may receive channel assignment instructions from the controller based on the perceived RSSI that the BKD received the signal at from the AP and the frequency on which the AP received the data packet.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Ambient Power (AMP) Backscatter Devices (BKDs) may use ambient energy, for example, Radio Frequency (RF) signals to transmit data without a power source such as a battery or a connection to electricity. BKDs may use an antenna to receive the RF signals, use the RF signals for excitation (e.g., convert the RF signal into electricity), and use the power to modify and reflect the RF signals with data. Other devices may receive reflected RF signals transmitted by a BKD to process the data the BKD is sending.

There may be two types of BKDs: i) passive BKDs (pBKDs) and ii) active BKDs (aBKDs). A pBKD may directly reflect back the energy it receives. An aBKD may include a capacitor and may thus charge until it sends its own frame. As discussed above, BKDs may be powered by ambient energy (for example, RF signals such as Wi-Fi signals or cellular signals) present in the surrounding environment.

The Ambient Power group (AMP) is considering ways to allow the integration of such BKD devices into Wi-Fi networks, so that they may coexist with existing Wi-Fi devices with minimal interference. In either pBKD or aBKD mode, the AMP Station (STA) transmission may interfere with neighboring Wi-Fi devices transmissions. This may even be more challenging because the AMP STA may transmit at any time when the energy storage device has enough energy to transmit, and the device may neither contend for the medium, nor wait for instructions from an AP to transmit.

Conventional processes may ignore this problem (as they may focus on the AMP STA as the primary subject). Thus, there is a need for a process that may allow the coexistence of AMP STA transmissions with standard Wi-Fi devices. Embodiments of the disclosure may leverage the transmission of a short sequence of bits indicating an AP's received power level at the AMP STA device and the cooperation of designated buddy devices in the near proximity of the STA AMP to carry useful information to the AP/wireless controller that may be used to improve the existing Dynamic Channel Allocation (DCA) and Resource Radio Management (RRM).

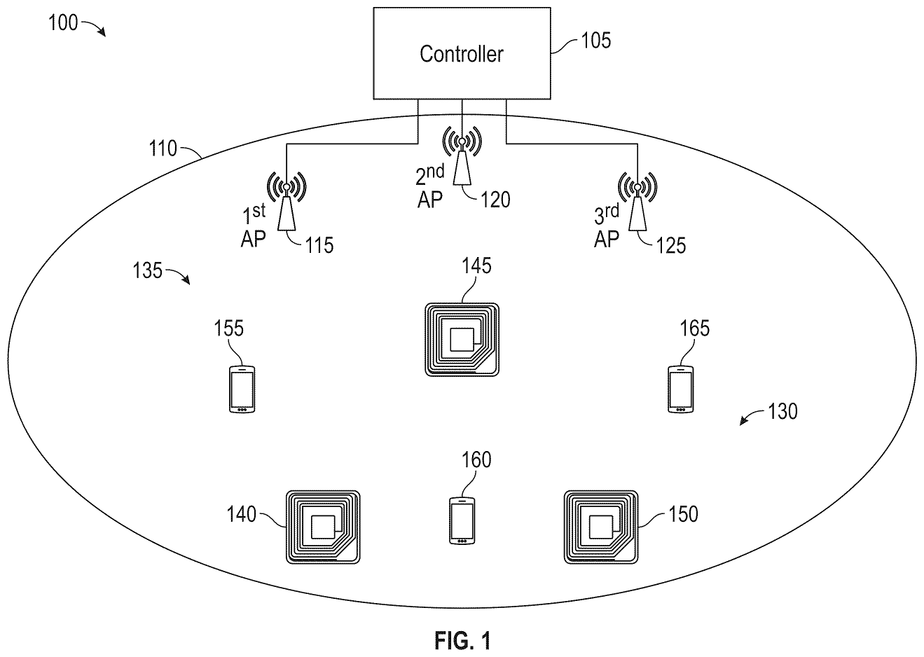

FIG. 1 shows an operating environment 100 for providing Wireless Local-Area Network (WLAN) channel management in the presence of Ambient Power (AMP) devices. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 115, a second AP 120, and a third AP 125. Each of the plurality of APs may be compatible with specification standards such as, but not limited to, the Institute of Electrical and Electronics Engineers (IEEE) 802.11 specification standard for example.

A first plurality of devices 130 and a second plurality of devices 135 (i.e., STAs) may be deployed in coverage environment 110. The plurality of APs may provide wireless network access to first plurality of devices 130 and second plurality of devices 135 as the devices move within coverage environment 110. Coverage environment 110 may comprise an outdoor or indoor wireless environment for Wi-Fi or any type of wireless protocol or standard.

First plurality of devices 130 may comprise a first device 140, a second device 145, and a third device 150. First plurality of devices 130 may comprise BKDs, for example, Radio Frequency Identifier (RFID) tags. First plurality of devices 130 may comprise, but are not limited to, general energy harvesting devices (e.g., passive backscatter communication devices) and pure backscatter communication devices. General energy harvesting devices may comprise devices that work in two phases: i) first harvesting RF energy for a time period; then ii) transmitting using this harvested RF energy. General energy harvesting devices may comprise battery-less Bluetooth Low Energy (BLE) chips for example. With a pure backscatter communication device, the RF signal that provides power may also be the one that is backscattered/modified according to some modulation hence encoding some symbols of information. In addition, first plurality of devices 130 may comprise devices that may receive or harvest energy from light energy and then use the energy from light to power transmission. First plurality of devices 130 may also comprise devices that may harvest RF energy to recharge a battery or other energy storage element (e.g., a capacitor) within the device.

Second plurality of devices 135 may comprise a first client device 155, a second client device 160, and a third client device 165. Ones of second plurality of devices 135 may comprise, but are not limited to, a smart phone, a personal computer, a tablet device, a mobile device, a telephone, a remote control device, a set-top box, a digital video recorder, an Internet-of-Things (IoT) device, a network computer, a router, an AR/VR device an Automated Transfer Vehicle (ATV), a drone, an Unmanned Aerial Vehicle (UAV), a smart wireless light bulb, or other similar microcomputer-based device.

Controller 105 may comprise a Wireless Local Area Network controller (WLC) and may provision and control coverage environment 110 (e.g., a WLAN). Controller 105 may allow the plurality of client devices to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide WLAN channel management in the presence of AMP devices.

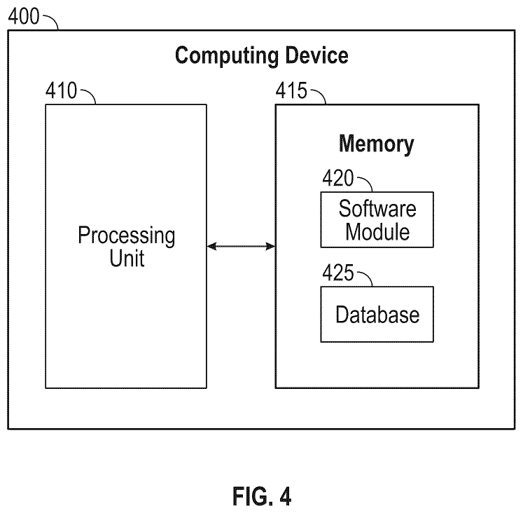

The elements described above of operating environment 100 (e.g., controller 105, first AP 115, second AP 120, third AP 125, first device 140, second device 145, third device 150, first client device 155, second client device 160, and third client device 165) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

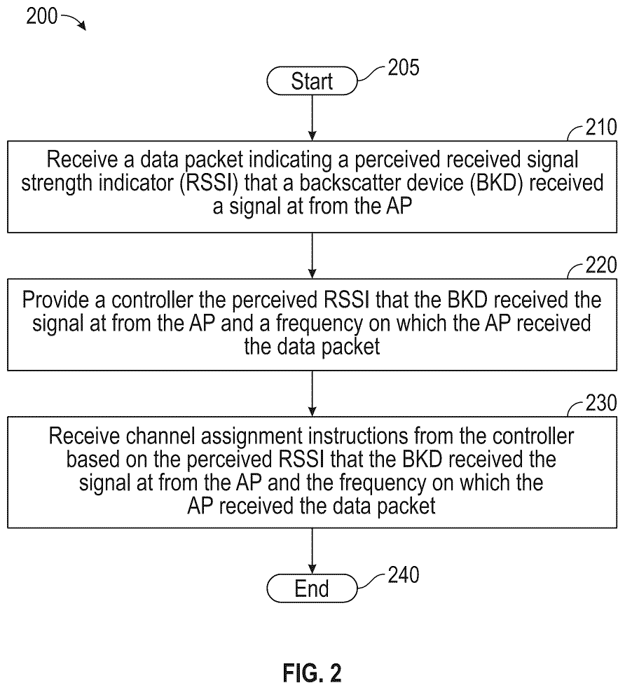

FIG. 2 is a flow chart setting forth the general stages involved in a method 200 consistent with embodiments of the disclosure for providing WLAN channel management in the presence of AMP devices. Method 200 may be implemented using first AP 115 as described in more detail above with respect to FIG. 1. Ways to implement the stages of method 200 will be described in greater detail below.

AMP STAs may transmit at different frequencies. Some AMP STAs (i.e., pBKDs) may simply reflect the signal on the carrier frequency at which the energy-bearing signal was received. More complex active AMP STAs (i.e., aBKDs) may store the incoming signal and retransmit at a different frequency. Embodiments of the disclosure may provide a process where the AP may gather information about the frequencies used by the surrounding AMP STA devices in coverage environment 110 and uses this information as a new input to its DCA and RRM algorithms.

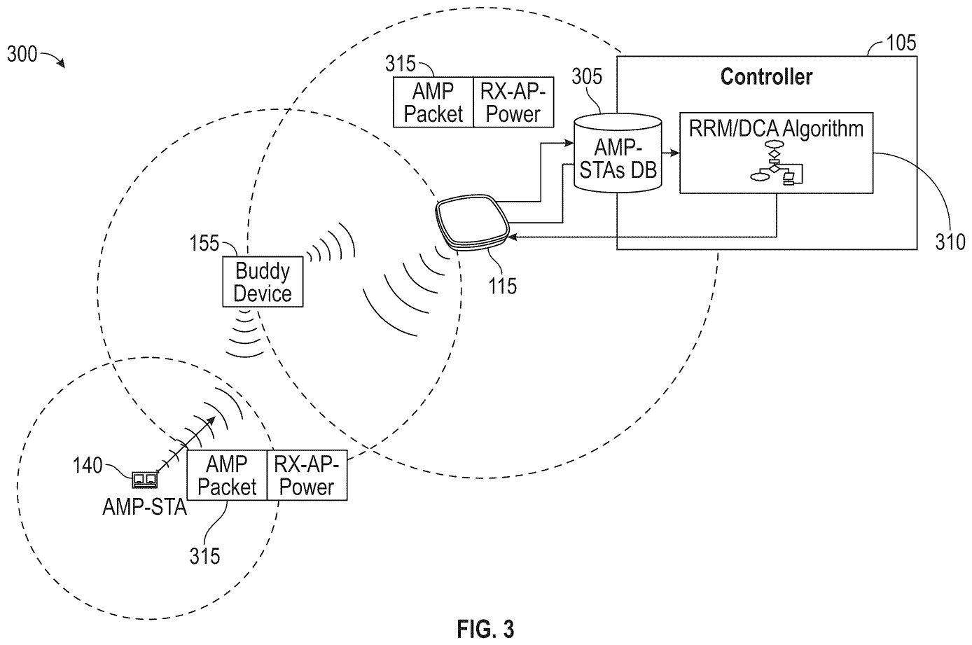

Method 200 may begin at starting block 205 and proceed to stage 210 where first AP 115 may receive a data packet indicating a perceived Received Signal Strength Indicator (RSSI) that a Backscatter Device (BKD) (e.g., first device 140) received a signal at from first AP 115. For example, first AP 115 may continuously scan the RF environment of coverage environment 110 as shown in FIG. 3. First AP 115 may take note of the AMP STAs that are backscattering signals at any point in time, along with the frequencies they use. Such information may be stored in an AMP-STAs database 305, similar to what happens with other interfering devices (e.g., microwave ovens, etc.) and rogue devices. When running a RRM/DCA algorithm 310, the presence of such devices may be taken into consideration by controller 105 to steer their outcome and better manage the WLAN channels.

However, because AMP STAs (e.g., first plurality of devices 130) may transmit at such low power compared to regular Wi-Fi devices (e.g., second plurality of devices 135), more information may be needed by controller 105 to correctly manage the channels. Consistent with embodiments of the disclosure, AMP STA devices may provide feedback to APs about their RSSI, which may help RRM functionalities determine the extent of AP range and impact of AMP STAs.

To optimize energy conservation on the AMP STA, the reported RSSI level may be appended to the end of their normal data transmission (e.g., data packet 315) as a short bit sequence. This sequence may be recognized by both AP (e.g., first AP 115) and a buddy device (e.g., first client device 155) as the perceived RSSI indicator of the AMP STA (e.g., first device 140), and may be for controller 105 to use in its RRM calculations (this may not need to be done at all times and could be staggered once every nth transmission, etc.).

In another embodiment, first AP 115 may delegate the function of sweeping the channels to other devices, such as the AMP buddy device (e.g., first client device 155) in the same Extended Service Set (ESS), based on better proximity to the individual AMP STAs (e.g., first device 140). Coordination among devices may happen, for example, through an exchange of Inter-Access Point Protocol (IAPP) messages or via another channel.

From stage 210, where first AP 115 receives data packet 315 indicating the perceived RSSI that the BKD (e.g., first device 140) received the signal at from first AP 115, method 200 may advance to stage 220 where first AP 115 may provide controller 105 the perceived RSSI that the BKD (e.g., first device 140) received the signal at from first AP 115 and a frequency on which first AP 115 received data packet 315. For example, first AP 115 may store data packet 315 in AMP-STAs database 305 where controller 105 may have access to it. First AP 115 may indicate the BKD from which data packet 315 was received and an identifier of the BKD.

Once first AP 115 provides controller 105 the perceived RSSI that the BKD (e.g., first device 140) received the signal at from first AP 115 and the frequency on which first AP 115 received the data packet in stage 220, method 200 may continue to stage 230 where first AP 115 may receive channel assignment instructions from controller 105 based on the perceived RSSI that the BKD (e.g., first device 140) received the signal at from first AP 115 and the frequency on which first AP 115 received the data packet. For example, RRM may fail to provide a clean wide channel bandwidth to first AP 115. In this scenario controller 105 may recommend first AP 115 use a narrower channel or recommend first AP 115 use a wider bandwidth channel while using puncturing.

With the puncturing approach, first AP 115 may be able to transition the AMP STA devices (e.g., first device 140) to only use the punctured frequencies to operate while assigning the rest of the wideband channel to regular Wi-Fi traffic (e.g., second plurality of devices 135) thus eliminating a source of backscatter interference. The amount of puncturing may be dynamically controlled by first AP 115 with recommendations from RRM/DCA algorithm 310 in controller 105. Once first AP 115 receives the channel assignment instructions from controller 105 based on the perceived RSSI that the BKD (e.g., first device 140) received the signal at from first AP 115 and the frequency on which first AP 115 received the data packet in stage 230, method 200 may then end at stage 240.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing WLAN channel management in the presence of AMP devices described with respect to FIG. 2. Computing device 400, for example, may provide an operating environment for controller 105, first AP 115, second AP 120, third AP 125, first device 140, second device 145, third device 150, first client device 155, second client device 160, and third client device 165. Controller 105, first AP 115, second AP 120, third AP 125, first device 140, second device 145, third device 150, first client device 155, second client device 160, and third client device 165 may operate in other environments and are not limited to computing device 400.

Computing device 400 may be implemented using an AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving, by an Access Point (AP), a data packet indicating a perceived Received Signal Strength Indicator (RSSI) that a Backscatter Device (BKD) received a signal at from the AP;
providing a controller the perceived RSSI that the BKD received the signal at from the AP and a frequency on which the AP received the data packet; and
receiving channel assignment instructions from the controller based on the perceived RSSI that the BKD received the signal at from the AP and the frequency on which the AP received the data packet.

2. The method of claim 1, wherein the data packet includes other data the BKD is communicating to the AP.

3. The method of claim 2, wherein the perceived RSSI is appended to an end of the data packet.

4. The method of claim 2, wherein the perceived RSSI is appended to the end of the data packet every n^{th} transmission.

5. The method of claim 1, wherein the data packet is received by the AP via a buddy device.

6. The method of claim 1, wherein the channel assignment instructions instruct the AP to use a narrower channel.

7. The method of claim 1, wherein the channel assignment instructions instruct the AP to use a wider bandwidth channel while using puncturing.

8. A system comprising:
a memory storage; and
a processing unit coupled to the memory storage and disposed in an Access Point (AP), wherein the processing unit is operative to:
receive a data packet indicating a perceived Received Signal Strength Indicator (RSSI) that a Backscatter Device (BKD) received a signal at from the AP;
provide a controller the perceived RSSI that the BKD received the signal at from the AP and a frequency on which the AP received the data packet; and
receive channel assignment instructions from the controller based on the perceived RSSI that the BKD received the signal at from the AP and the frequency on which the AP received the data packet.

9. The system of claim 8, wherein the data packet includes other data the BKD is communicating to the AP.

10. The system of claim 9, wherein the perceived RSSI is appended to an end of the data packet.

11. The system of claim 8, wherein the perceived RSSI is appended to the end of the data packet every n^{th} transmission.

12. The system of claim 8, wherein the data packet is received by the AP via a buddy device.

13. The system of claim 8, wherein the channel assignment instructions instruct one of the following: the AP to use a narrower channel; and the AP to use a wider bandwidth channel while using puncturing.

14. A non-transitory computer-readable medium that stores a set of instructions which when executed perform a method executed by the set of instructions comprising:
receiving, by an Access Point (AP), a data packet indicating a perceived Received Signal Strength Indicator (RSSI) that a Backscatter Device (BKD) received a signal at from the AP;
providing a controller the perceived RSSI that the BKD received the signal at from the AP and a frequency on which the AP received the data packet; and
receiving channel assignment instructions from the controller based on the perceived RSSI that the BKD received the signal at from the AP and the frequency on which the AP received the data packet.

15. The non-transitory computer-readable medium of claim 14, wherein the data packet includes other data the BKD is communicating to the AP.

16. The non-transitory computer-readable medium of claim 15, wherein the perceived RSSI is appended to an end of the data packet.

17. The non-transitory computer-readable medium of claim 16, wherein the perceived RSSI is appended to the end of the data packet every n^{th} transmission.

18. The non-transitory computer-readable medium of claim 14, wherein the data packet is received by the AP via a buddy device.

19. The non-transitory computer-readable medium of claim 14, wherein the channel assignment instructions instruct the AP to use a narrower channel.

20. The non-transitory computer-readable medium of claim 14, wherein the channel assignment instructions instruct the AP to use a wider bandwidth channel while using puncturing.
